(19) United States
(12) Patent Application Publication
(10) Pub. No.: US 2017/0331116 A1
(43) Pub. Date: Nov. 16, 2017

(54) LITHIUM-PHOSPHORUS-BASED COMPOSITE OXIDE/CARBON COMPOSITE AND METHOD FOR MANUFACTURING THE SAME, ELECTROCHEMICAL DEVICE AND LITHIUM ION SECONDARY BATTERY

(71) Applicant: SHIN-ETSU CHEMICAL CO., LTD., Tokyo (JP)

(72) Inventors: Hidekazu AWANO, Takasaki-shi (JP); Hiromichi KAMO, Takasaki-shi (JP); Takakazu HIROSE, Annaka-shi (JP); Hiroki YOSHIKAWA, Takasaki-shi (JP)

(73) Assignee: SHIN-ETSU CHEMICAL CO., LTD., Tokyo (JP)

(21) Appl. No.: 15/535,518

(22) PCT Filed: Nov. 13, 2015
(86) PCT No.: PCT/JP2015/005670

§ 371 Date: Jun. 13, 2017

(30) Foreign Application Priority Data
Dec. 25, 2014 (JP) 2014-261986

(51) Int. Cl. H01M 4/66; H01M 10/0525; H01M 4/1315; C01G 31/00; C01G 33/00

(52) U.S. Cl. CPC H01M 4/665; H01M 10/0525; H01M 4/1315; C01G 33/006; C01G 31/006

(57) ABSTRACT

The present invention is a lithium-phosphorus-based composite oxide/carbon composite used for a positive electrode active material of an electrochemical device, including lithium-phosphorus-based composite oxide with the surface being coated with carbon, wherein the lithium-phosphorus-based composite oxide/carbon composite has elutable fluoride ions, which are eluted to an elute from the composite dispersed to ultrapure water, in a mass ratio of 500 ppm or more and 15000 ppm or less in comparison with the lithium-phosphorus-based composite oxide/carbon composite, and the lithium-phosphorus-based composite oxide has a composition of the following general formula (1):

Li₁₋ₓFe_{1-z}M_{z}PO₄₋ₐFₐ(−0.1≦x<1,0≦z≦1,0≦a≦4) (1)

(wherein, M represents one or more kinds of metal element selected from the group of Mn, Ni, Co, V, Cr, Al, Nb, Ti, Cu, and Zn). This provides a lithium-phosphorus-based composite oxide/carbon composite that gives higher charge/discharge capacity when it is used as a positive electrode active material of an electrochemical device even though a trivalent-containing raw material is used.

### TECHNICAL FIELD

The present invention relates to a lithium-phosphorus-based composite oxide/carbon composite and a method for manufacturing the same, as well as an electrochemical device and a lithium ion secondary battery using the lithium-phosphorus-based composite oxide/carbon composite.

### BACKGROUND ART

With the widespread diffusion of small-sized electronic devices such as a mobile terminal in recent years, further miniaturization, weight saving, and life-elongation of the electronic devices are highly required. For these market demands, development of secondary battery is proceeding, in particular a small-sized, light weight one which can achieve a high energy density. This secondary battery is also evaluated to apply to large-sized electronic devices such as an automobile, electric power storage systems such as a house, not only to small-sized electronic devices.

Above all, lithium ion secondary battery is greatly expected, since it is liable to achieve small-size and high capacity. This is also due to capability to give higher energy density compared to a lead battery or a nickel-cadmium battery.

A lithium ion secondary battery is provided with a positive electrode and a negative electrode, as well as a separator and an electrolytic solution. These positive electrode and negative electrode contain a positive electrode active material and a negative electrode active material which participate in charge/discharge reaction.

As the positive electrode active material for a lithium ion secondary battery, lithium-iron phosphate (LiFePO₄) having an olivine type crystal structure has been gaining attention recently.

In this LiFePO₄, phosphorus (P) is contained as the constitutive element, and all of the oxygens are covalently bonded to the phosphorus strongly. Accordingly, it is excellent in heat stability without releasing oxygen even in a higher temperature and is suited for the application to electrode active material of high output and high capacity secondary battery. This also contains one lithium atom that can be eliminated/inserted by the charge/discharge per a Fe atom thereof, and has been investigated as a new positive electrode active material for a lithium secondary battery to replace lithium cobalt oxide.

### CITATION LIST

### Patent Literature

Patent Document 1: Japanese Unexamined Patent Application publication (Kokai) No. 2005-108681
Patent Document 2: Japanese Unexamined Patent Application publication (Kokai) No. 2012-195158
Patent Document 3: Japanese Unexamined Patent Application publication (Kokai) No. 2013-058391
Patent Document 4: Japanese Unexamined Patent Application publication (Kokai) No. 2000-015216
Patent Document 5: Japanese Unexamined Patent Application publication (Kokai) No. 2000-231941
Patent Document 6: Japanese Unexamined Patent Application publication (Kokai) No. 2004-349210
Patent Document 7: Japanese Unexamined Patent Application publication (Kokai) No. H08-022846
Patent Document 8: Japanese Unexamined Patent Application publication (Kokai) No. H10-330855

### SUMMARY OF INVENTION

### Problem to be Solved by the Invention

However, lithium-iron phosphate (LiFePO₄)/carbon composite produced by conventional method is a composite with conductive carbon material. The production process is complicated to cause high processing cost. In order to reduce the processing cost, it is preferable to synthesize lithium-iron phosphate by using a raw material composed of trivalent iron, which can be easily synthesized. In the use of raw material of trivalent iron, however, a step of reduction is necessary, and there was a problem that sufficient charge/discharge capacity cannot be obtained.

In the lithium-phosphorus-based composite oxide/carbon composite proposed in Patent Document 1, raw material of divalent iron and raw material of trivalent iron are used. The raw material of trivalent iron contains lithium, and the crystallinity cannot be sufficiently improved only by baking after adding a lithium compound. Accordingly, it is still insufficient in the charge/discharge capacity relating to elimination and insertion of lithium.

Patent Document 2 describes a synthesis of a lithium-phosphorus-based composite oxide/carbon composite proposed therein from a raw material of trivalent FePO₄.nH₂O. However, this is also still insufficient with respect to the charge/discharge capacity.

Patent Document 3 proposes a method to pulverize an inorganic compound comprising a crystal that contains trivalent iron as the constitutive element. This method, however, cannot give highly crystalline olivine iron that has higher charge/discharge capacity.

The method proposed in Patent Document 4, in which the positive electrode is taken out from a lithium ion secondary battery and dissolved, is disadvantageous in view of productivity since the positive electrode have to be once dissolved.

Patent Document 5 proposes a method for recrystallizing a positive electrode, being degraded and changed to amorphous, by baking followed by cooling at a prescribed speed. In this method, the lithium content is not uniform in the positive electrode used for regenerating, which causes to form an inactive oxide layer on a part of the positive electrode surface in the regenerating to fail to give sufficient charge/discharge capacity.

In the regenerating method proposed in Patent Document 6, which has a baking step to bake the positive electrode at the baking temperature of 750° C. or more and 1000° C. or less and cooling step to cool the same from the baking temperature to a prescribed temperature at a rate of 0.2° C. to 2.0° C./min, it is difficult to restore the active material only by re-baking in a state having non-uniformly eliminated/inserted lithium, and it is hard to reproduce the higher charge/discharge capacity.

In the methods disclosed in Patent Documents 7 and 8, the elements contained in the positive electrode material can be recovered, but it has been difficult to regenerate the intact recovered material to a positive electrode active material. That is, Patent Documents 7 and 8 do not describe detailed treatment conditions of the disclosed methods, and it has been difficult to regenerate the function as a positive electrode active material (positive electrode capacity) even if the treatment is performed with using conventional conditions as conditions which are not disclosed.

The present invention was accomplished in view of the above-described problems. It is an object of the present invention to provide a lithium-phosphorus-based composite oxide/carbon composite that gives higher charge/discharge capacity when it is used as a positive electrode active material of an electrochemical device even though a trivalent-containing raw material is used, together with a method for producing the same.

### Means for Solving Problem

To achieve the above-described object, the present invention provides a lithium-phosphorus-based composite oxide/carbon composite used for a positive electrode active material of an electrochemical device, comprising lithium-phosphorus-based composite oxide with the surface being coated with carbon,

wherein the lithium-phosphorus-based composite oxide/carbon composite has elutable fluoride ions, the elutable fluoride ions being eluted to an elute from the lithium-phosphorus-based composite oxide/carbon composite when the lithium-phosphorus-based composite oxide/carbon composite is dispersed to ultrapure water, in a mass ratio of 500 ppm or more and 15000 ppm or less in comparison with the lithium-phosphorus-based composite oxide/carbon composite, and

the lithium-phosphorus-based composite oxide has a composition of the following general formula (1):

Li₁₋ₓFe_{1-z}M_{z}PO₄₋ₐFₐ(−0.1≦x<1,0≦z≦1,0≦a≦4) (1)

(wherein, M represents one or more kinds of metal element selected from the group of Mn, Ni, Co, V, Cr, Al, Nb, Ti, Cu, and Zn).

Such a lithium-phosphorus-based composite oxide/carbon composite allows lithium ions to eliminate and insert smoothly when the composite is used as a positive electrode active material for an electrochemical device. This makes it possible to stably supply lithium ions appropriately, and can improve the charge/discharge capacity thereby.

It is preferable that the lithium-phosphorus-based composite oxide/carbon composite have elutable lithium ions, the elutable lithium ions being eluted to an elute from the lithium-phosphorus-based composite oxide/carbon composite when the lithium-phosphorus-based composite oxide/carbon composite is dispersed to ultrapure water, in a mass ratio of 500 ppm or more and 5000 ppm or less in comparison with the lithium-phosphorus-based composite oxide/carbon composite.

When the elutable lithium ions are in the foregoing mass ratio in comparison with the lithium-phosphorus-based composite oxide/carbon composite in an elute from the composite dispersed to ultrapure water, it is possible to effectively improve the charge/discharge capacity of an electrochemical device when the composite is used as the positive electrode active material of the electrochemical device.

It is preferable that the lithium-phosphorus-based composite oxide/carbon composite have elutable lithium ions and the elutable fluoride ions, the elutable lithium ions and the elutable fluoride ions being eluted to an elute from the lithium-phosphorus-based composite oxide/carbon composite dispersed to ultrapure water, in a mass ratio (the mass of the fluoride ions/the mass of the lithium ions) of 0.1 or more and 10 or less.

When the mass ratio of the elutable lithium ions and the elutable fluoride ions (the mass of the fluoride ions/the mass of the lithium ions) is in the foregoing range, it is possible to improve the charge/discharge capacity of an electrochemical device more surely when the composite is used as the positive electrode active material of the electrochemical device.

It is preferable that a peak corresponding to lithium phosphate is observed in a range of 20° or more and 25° or less in a 2θ value of X-ray diffraction measurement.

The lithium-phosphorus-based composite oxide/carbon composite having such an X-ray diffraction pattern can improve the charge/discharge capacity of an electrochemical device more surely when it is used as the positive electrode active material of the electrochemical device, and can be suitably used as a positive electrode active material for an electrochemical device.

It is preferable that the average particle size is 0.5 μm or more and 30.0 μm or less.

When the average particle size of the lithium-phosphorus-based composite oxide/carbon composite is in the foregoing range, it is possible to improve the charge/discharge capacity of an electrochemical device more effectively when the composite is used as the positive electrode active material of the electrochemical device.

It is preferable that the BET specific surface area is 5.0 m²/g or more and 50.0 m²/g or less.

When the BET specific surface area of the lithium-phosphorus-based composite oxide/carbon composite is in the foregoing range, it is possible to improve the charge/discharge capacity of an electrochemical device more effectively when the composite is used as the positive electrode active material of the electrochemical device.

The present invention also provides a method for producing a lithium-phosphorus-based composite oxide/carbon composite containing lithium-phosphorus-based composite oxide having a composition of the following general formula (1) with the surface being coated with carbon:

Li₁₋ₓFe_{1-z}M_{z}PO₄₋ₐFₐ(−0.1≦x<1,0≦z≦1,0≦a≦4) (1)

(wherein, M represents one or more kinds of metal element selected from the group of Mn, Ni, Co, V, Cr, Al, Nb, Ti, Cu, and Zn), comprising the steps of:

mixing and then reacting a lithium compound and a lithium-phosphorus-based composite oxide-precursor having a composition of the following general formula (2) with the lithium being extracted:

Li_{1-y}Fe_{1-z}M_{z}PO_{4-b}F_{b}(x<y<1,0≦z≦1,0≦b≦4) (2)

(wherein, M represents one or more kinds of metal element selected from the group of Mn, Ni, Co, V, Cr, Al, Nb, Ti, Cu, and Zn),

using a carbon coated lithium-phosphorus-based composite oxide-precursor as the lithium-phosphorus-based composite oxide-precursor, or coating the lithium-phosphorus-based composite oxide-precursor or the lithium-phosphorus-based composite oxide with carbon,

wherein, by using as the lithium-phosphorus-based composite oxide-precursor the lithium compound one containing fluorine, the produced lithium-phosphorus-based composite oxide/carbon composite has elutable fluoride ions, the elutable fluoride ions being eluted to an elute when the lithium-phosphorus-based composite oxide/carbon composite is dispersed to ultrapure water, in a mass ratio of 500 ppm or more and 15000 ppm or less in comparison with the lithium-phosphorus-based composite oxide/carbon composite.

Such a production method can surely produce a lithium-phosphorus-based composite oxide/carbon composite having elutable fluoride ions, the elutable fluoride ions being eluted to an elute from the lithium-phosphorus-based composite oxide/carbon composite dispersed to ultrapure water, in the prescribed range of mass ratio in comparison with the lithium-phosphorus-based composite oxide/carbon composite.

The lithium-phosphorus-based composite oxide-precursor is preferably a lithium-phosphorus-based composite oxide-precursor with the lithium being extracted electrochemically.

Such a method can be suitably used as a method to subtract the lithium.

The lithium-phosphorus-based composite oxide-precursor is preferably a lithium-phosphorus-based composite oxide-precursor with the lithium being extracted electrochemically after molding the lithium-phosphorus-based composite oxide-precursor so as to have a thickness of 1.0 mm or more.

Such a method also can be suitably used as a method to subtract the lithium.

The foregoing lithium compound preferably contains lithium hexafluorophosphate (LiPF₆).

The lithium-phosphorus-based composite oxide/carbon composite can have fluorine by using a lithium compound that contains lithium hexafluorophosphate as the lithium compound to be reacted with the lithium-phosphorus-based composite oxide-precursor.

The foregoing lithium compound preferably contains lithium tetrafluoroborate (LiBF₄).

The lithium-phosphorus-based composite oxide/carbon composite can have fluorine by using a lithium compound that contains lithium tetrafluoroborate as the lithium compound to be reacted with a lithium-phosphorus-based composite oxide-precursor.

It is preferable that the reacting step includes a baking stage, and in the baking stage, the baking temperature is 500° C. or more and 1000° C. or less.

The method to perform baking in the foregoing temperature region can be suitably used as the method to react the lithium compound and the lithium-phosphorus-based composite oxide-precursor.

It is preferable that the reacting step includes a baking stage, and the baking stage is performed in a nitrogen atmosphere.

The baking in a nitrogen atmosphere can prevent oxidation of the lithium-phosphorus-based composite oxide/carbon composite.

It is preferable that the reacting step includes a baking stage, and the baking stage is performed in an argon atmosphere.

The baking in an argon atmosphere can prevent oxidation of the lithium-phosphorus-based composite oxide/carbon composite.

The present invention further provides an electrochemical device, comprising:

a negative electrode composed of a negative electrode current collector and a negative electrode active material layer containing a particle of negative electrode active material that has charge/discharge efficiency of 80% or less when the particle of negative electrode active material is used as a negative electrode active material for the electrochemical device, and

a positive electrode composed of a positive electrode current collector and a positive electrode active material layer containing the lithium-phosphorus-based composite oxide/carbon composite described above.

Such an electrochemical device can have higher charge/discharge capacity.

The present invention also provides an electrochemical device, comprising:

a negative electrode composed of a negative electrode current collector and a negative electrode active material layer containing a particle of negative electrode active material that contains silicon oxide shown by the composition formula of SiOₓ (0.5≦x<1.6), and

a positive electrode composed of a positive electrode current collector and a positive electrode active material layer containing the lithium-phosphorus-based composite oxide/carbon composite described above.

Such an electrochemical device can have higher charge/discharge capacity.

The present invention also provides a lithium ion secondary battery, comprising:

a negative electrode composed of a negative electrode current collector and a negative electrode active material layer containing a particle of negative electrode active material that has charge/discharge efficiency of 80% or less when the particle of negative electrode active material is used as a negative electrode active material for the lithium ion secondary battery, and

a positive electrode composed of a positive electrode current collector and a positive electrode active material layer containing the lithium-phosphorus-based composite oxide/carbon composite described above.

Such a lithium ion secondary battery can have higher charge/discharge capacity.

The present invention also provides a lithium ion secondary battery, comprising:

a negative electrode composed of a negative electrode current collector and a negative electrode active material layer containing a particle of negative electrode active material that contains silicon oxide shown by the composition formula of SiOₓ (0.5≦x<1.6), and

a positive electrode composed of a positive electrode current collector and a positive electrode active material layer containing the lithium-phosphorus-based composite oxide/carbon composite described above.

Such a lithium ion secondary battery can have higher charge/discharge capacity.

### Effect of Invention

As described above, the inventive lithium-phosphorus-based composite oxide/carbon composite allows lithium ions to eliminate and insert smoothly when the composite is used as a positive electrode active material for an electrochemical device; which makes it possible to stably supply lithium ions appropriately, and can improve the charge/discharge capacity thereby. The inventive method for producing a lithium-phosphorus-based composite oxide/carbon composite can surely produce a lithium-phosphorus-based composite oxide/carbon composite that has elutable fluoride ions in the prescribed range of mass ratio in comparison with the lithium-phosphorus-based composite oxide/carbon composite in an elute when the lithium-phosphorus-based composite oxide/carbon composite is dispersed to ultrapure water. Furthermore, the inventive electrochemical device can have higher charge/discharge capacity. The inventive lithium ion secondary battery can have higher charge/discharge capacity.

### BRIEF DESCRIPTION OF DRAWINGS

FIG. 1 is a diagram showing an X-ray diffraction pattern of the lithium-phosphorus-based composite oxide/carbon composite of Example 1.

### DESCRIPTION OF EMBODIMENTS

Hereinafter, the present invention will be specifically described as an example of the embodiment, but the present invention is not limited thereto.

As described above, lithium-iron phosphate (LiFePO₄)/carbon composite produced by conventional method is a composite with conductive carbon material. The production process is complicated to cause high processing cost. In order to reduce the processing cost, it is preferable to synthesize lithium-iron phosphate by using a raw material composed of trivalent iron, which can be easily synthesized. In the use of raw material of trivalent iron, however, a step of reduction is necessary, and higher charge/discharge capacity cannot be obtained.

Accordingly, the present inventors have diligently investigated a lithium-phosphorus-based composite oxide/carbon composite that can provide an electrochemical device with higher charge/discharge capacity when the composite is used as the positive electrode active material thereof even when a raw material of trivalent iron was used. As a result, the present inventors have found that higher charge/discharge capacity can be obtained by using a lithium-phosphorus-based composite oxide/carbon composite that has elutable fluoride ions, the elutable fluoride ions being eluted to an elute from the lithium-phosphorus-based composite oxide/carbon composite dispersed to ultrapure water, in a mass ratio of 500 ppm or more and 15000 ppm or less in comparison with the lithium-phosphorus-based composite oxide/carbon composite as a positive electrode active material for an electrochemical device even when a raw material of trivalent iron is used; thereby brought the present inventive to completion.

First, the inventive lithium-phosphorus-based composite oxide/carbon composite will be described.

The inventive lithium-phosphorus-based composite oxide/carbon composite is a lithium-phosphorus-based composite oxide/carbon composite used for a positive electrode active material of an electrochemical device, comprising lithium-phosphorus-based composite oxide with the surface being coated with carbon,

wherein the lithium-phosphorus-based composite oxide/carbon composite has elutable fluoride ions, which are eluted to an elute from the composite dispersed to ultrapure water, in a mass ratio of 500 ppm or more and 15000 ppm or less, more preferably 1000 ppm or more and 15000 ppm or less, still more preferably 1500 ppm or more and 15000 ppm or less in comparison with the lithium-phosphorus-based composite oxide/carbon composite, and

the lithium-phosphorus-based composite oxide has a composition of the following general formula (1):

Li₁₋ₓFe_{1-z}M_{z}PO₄₋ₐFₐ(0≦x<1,0≦z≦1,0≦a≦4) (1)

(wherein, M represents one or more kinds of metal element selected from the group of Mn, Ni, Co, V, Cr, Al, Nb, Ti, Cu, and Zn). Herein, “x” is more preferably 0≦x<0.5, still more preferably 0≦x<0.3; “z” is more preferably 0<z<0.7, still more preferably 0<z<0.4.

Such a lithium-phosphorus-based composite oxide/carbon composite allows lithium ions to eliminate and insert smoothly when the composite is used as a positive electrode active material for an electrochemical device. This makes it possible to stably supply lithium ions appropriately, and can improve the charge/discharge capacity thereby. It is conceivable that the elutable fluoride ions are each contained in a form of LiF on the surface of the composite. In the present invention, however, it is important that the amount of fluoride ions be in the foregoing prescribed region when it is eluted as described above. The fluorine can be solid-solved in a base material in some cases.

The lithium-phosphorus-based composite oxide/carbon composite preferably has elutable lithium ions, which are eluted to an elute when the composite is dispersed to ultrapure water and filtered out, in a mass ratio of 500 ppm or more and 5000 ppm or less, more preferably 600 ppm or more and 5000 ppm or less, still more preferably 1000 ppm or more and 5000 ppm or less in comparison with the lithium-phosphorus-based composite oxide/carbon composite.

When the mass ratio of the elutable lithium ions, which are eluted to an elute when the composite is dispersed to ultrapure water and filtered out, is in the foregoing range in comparison with the lithium-phosphorus-based composite oxide/carbon composite, it is possible to effectively improve the charge/discharge capacity of an electrochemical device when the composite is used as the positive electrode active material of the electrochemical device.

The lithium-phosphorus-based composite oxide/carbon composite preferably has elutable lithium ions and the elutable fluoride ions, which are eluted to an elute when the composite is dispersed to ultrapure water and filtered out, in a mass ratio (the mass of the fluoride ions/the mass of the lithium ions) of 0.1 or more and 10 or less, more preferably 0.5 or more and 8 or less.

When the mass ratio of the elutable lithium ions and the elutable fluoride ions (the mass of the fluoride ions/the mass of the lithium ions) is in the foregoing range, it is possible to improve the charge/discharge capacity of an electrochemical device more surely when the composite is used as the positive electrode active material of the electrochemical device. The amount of the elutable fluoride ions can be controlled by adjusting the amount of fluorine-containing electrolytic solution when reacting a lithium compound and a lithium-phosphorus-based composite oxide-precursor, for example. That is, the amount of the elutable fluoride ions can be controlled by adding the electrolytic solution and regenerating when fluorine is deficient, and by releasing the electrolytic solution with using centrifugation and so on when fluorine is excess. The amount of the elutable lithium ions can be controlled by the amount of lithium source other than the electrolytic solution, baking temperature, etc. when the amount of the elutable fluoride ions is determined.

The lithium-phosphorus-based composite oxide/carbon composite preferably has a peak corresponding to lithium phosphate in a range of 20° or more and 25° or less in a 2θ value of X-ray diffraction measurement. Furthermore, it is more preferable that the peak corresponding to lithium phosphate has smaller intensity.

The lithium-phosphorus-based composite oxide/carbon composite having such an X-ray diffraction pattern can improve the charge/discharge capacity of an electrochemical device more surely when it is used as the positive electrode active material of the electrochemical device, and can be suitably used as a positive electrode active material for the electrochemical device. When the obtained peak intensity of lithium phosphate is smaller to the same extent as the detection limit, a decrease of the charge/discharge capacity can be prevented.

The lithium-phosphorus-based composite oxide/carbon composite preferably has an average particle size (median diameter) of 0.5 μm or more and 30.0 μm or less, more preferably 1 μm or more and 20 μm or less. Herein, the average particle size is on a volume basis.

When the average particle size of the lithium-phosphorus-based composite oxide/carbon composite is in the foregoing range, it is possible to improve the charge/discharge capacity of an electrochemical device more effectively when the composite is used as the positive electrode active material of the electrochemical device,

The lithium-phosphorus-based composite oxide/carbon composite preferably has a BET specific surface area of 5.0 m²/g or more and 50.0 m²/g or less, more preferably 7.0 m²/g or more and 50.0 m²/g or less, still more preferably 10.0 m²/g or more and 50.0 m²/g or less. Herein, the BET specific surface area means a surface area per a unit mass measured by BET method (a method in which gas particles of nitrogen and so on are absorbed to the solid particles, and the surface area is measured on the basis of the absorbed amount).

When the BET specific surface area of the lithium-phosphorus-based composite oxide/carbon composite is in the foregoing range, it is possible to improve the charge/discharge capacity of an electrochemical device more effectively when the composite is used as the positive electrode active material of the electrochemical device.

In the lithium-phosphorus-based composite oxide/carbon composite, the content of conductive carbon material is preferably more than 0% by mass and 20% by mass or less, more preferably 1.0% by mass or more and 20% by mass or less, still more preferably 2% by mass or more and 20.0% by mass or less. Because this can improve the charge/discharge capacity of an electrochemical device more surely when the composite is used as the positive electrode active material of the electrochemical device.

The lithium-phosphorus-based composite oxide/carbon composite described above allows lithium ions to eliminate and insert smoothly when the composite is used as a positive electrode active material for an electrochemical device. This makes it possible to stably supply lithium ions appropriately, and can improve the charge/discharge capacity thereby.

Subsequently, the inventive method for producing a lithium-phosphorus-based composite oxide/carbon composite will be described.

The inventive method for producing a lithium-phosphorus-based composite oxide/carbon composite is a method for producing a lithium-phosphorus-based composite oxide/carbon composite containing lithium-phosphorus-based composite oxide having a composition of the following general formula (1) with the surface being coated with carbon:

Li₁₋ₓFe_{1-z}M_{z}PO₄₋ₐFₐ(−0.1≦x<1,0≦z≦1,0≦a≦4) (1)

(wherein, M represents one or more kinds of metal element selected from the group of Mn, Ni, Co, V, Cr, Al, Nb, Ti, Cu, and Zn), comprising the steps of:

mixing and then reacting a lithium compound and a lithium-phosphorus-based composite oxide-precursor having a composition of the following general formula (2) with the lithium being extracted:

Li_{1-y}Fe_{1-z}M_{z}PO_{4-b}F_{b}(x<y<1,0≦z≦1,0≦b≦4) (2)

(wherein, M represents one or more kinds of metal element selected from the group of Mn, Ni, Co, V, Cr, Al, Nb, Ti, Cu, and Zn),

using a carbon coated lithium-phosphorus-based composite oxide-precursor as the lithium-phosphorus-based composite oxide-precursor, or coating the lithium-phosphorus-based composite oxide-precursor or the lithium-phosphorus-based composite oxide with carbon,

wherein, by using as the lithium-phosphorus-based composite oxide-precursor or the lithium compound one containing fluorine, the produced lithium-phosphorus-based composite oxide/carbon composite has elutable fluoride ions, which are eluted to an elute when the composite is dispersed to ultrapure water, in a mass ratio of 500 ppm or more and 15000 ppm or less in comparison with the lithium-phosphorus-based composite oxide/carbon composite. Herein, “x” is more preferably 0≦x<0.5, still more preferably 0≦x<0.3; “y” is more preferably 0<y<0.8, still more preferably 0<y<0.6; “z” is more preferably 0<z<0.7, still more preferably 0<z<0.4.

Such a production method can surely produce a lithium-phosphorus-based composite oxide/carbon composite that has elutable fluoride ion in the foregoing prescribed range of mass ratio in comparison with the lithium-phosphorus-based composite oxide/carbon composite in an elute when the lithium-phosphorus-based composite oxide/carbon composite is dispersed to ultrapure water. The lithium-phosphorus-based composite oxide-precursor in which the lithium is extracted contains trivalent iron, thereby being difficult to be regenerated. When it is used as a raw material, however, it is possible to regenerate the lithium-phosphorus-based composite oxide used electrochemically, and to produce a lithium-phosphorus-based composite oxide/carbon composite with cost competitiveness thereby. Such a production method can reduce the amount of lithium compound to be used, and can produce a lithium-phosphorus-based composite oxide/carbon composite at lower cost thereby.

In the method for producing a lithium-phosphorus-based composite oxide/carbon composite described above, the lithium-phosphorus-based composite oxide-precursor with the lithium being extracted includes the one taken out from a used electrode after charging and discharging by dissolution with using organic solvent, the one in which the lithium is chemically extracted, the one in a state with the lithium ions being dispersed by baking at a higher temperature, and the one in a state with the lithium being extracted from powders or pellets by charging and discharging, for example. The lithium-phosphorus-based composite oxide-precursor is optionally coated with carbon. When using a lithium-phosphorus-based composite oxide-precursor in which the lithium is partly removed, part of the lithium remains, which can form a lithium-phosphorus-based composite oxide/carbon composite more easily, and can reduce the amount of the lithium compound to be used to produce a lithium-phosphorus-based composite oxide/carbon composite at lower cost when being compared with the case of using coprecipitated raw material. The lithium-phosphorus-based composite oxide-precursor of Li_{1-y}Fe_{1-z}M_{z}PO_{4-b}F_{b} may be regenerated from the state of Li_{1-y}Fe_{1-Z}M_{z}PO_{4-b}F_{b}(y=0) which is returned to an original state by charging and discharging.

In the method for producing a lithium-phosphorus-based composite oxide/carbon composite, the lithium-phosphorus-based composite oxide-precursor is preferably a one in which the lithium is extracted electrochemically (specifically, by charging and discharging).

Such a method can be suitably used as a method to extract the lithium. Because this makes it easier to extract the lithium.

In the method for producing a lithium-phosphorus-based composite oxide/carbon composite, it is preferable that the lithium-phosphorus-based composite oxide-precursor is a lithium-phosphorus-based composite oxide-precursor with the lithium being extracted electrochemically after molding so as to have a thickness of 1.0 mm or more, more preferably 5.0 mm or more.

Such a method can be suitably used as a method to extract the lithium. The lithium-phosphorus-based composite oxide-precursor has good handling when it is molded into the thickness described above.

In the method for producing a lithium-phosphorus-based composite oxide/carbon composite, the lithium compound includes lithium carbonate, lithium hydroxide, lithium oxide, lithium oxalate, lithium phosphate, lithium hexafluorophosphate, and lithium tetrafluoroborate, for example; and is preferably lithium hydroxide, more preferably a mixture of lithium hydroxide and lithium hexafluorophosphate or a mixture of lithium hydroxide and lithium tetrafluoroborate, still more preferably a mixture of lithium hydroxide and lithium hexafluorophosphate.

Lithium hydroxide is particularly preferable, since it is industrially available with ease, highly reactive, and low cost. Lithium hexafluorophosphate and lithium tetrafluoroborate are good lithium conductor that is contained in an electrolyte solution as an electrolyte, and are ideal lithium compounds to achieve excellent charge/discharge capacity.

In the method for producing a lithium-phosphorus-based composite oxide/carbon composite, it is preferable that the reacting step include a baking stage, and the baking temperature is preferably 500° C. or more and 1000° C. or less, more preferably 550° C. or more and 900° C. or less, still more preferably 550° C. or more and 800° C. or less in the baking stage.

The method to perform baking at the foregoing temperature range can be suitably used as a method for reacting the lithium-phosphorus-based composite oxide-precursor and a lithium compound(s). The baking time is preferably 1 hour or more and 50 hours or less, more preferably 2 hours or more and 15 hours or less, still more preferably 2 hours or more and 8 hours or less. Furthermore, it is preferable to perform a calcination step before the baking. The calcination temperature is preferably 150° C. or more and 450° C. or less, more preferably 200° C. or more and 300° C. or less; the calcination time is preferably 30 minutes or more and 5 hours or less, more preferably 2 hours or more and 5 hours or less.

In the method for producing a lithium-phosphorus-based composite oxide/carbon composite, the baking is preferably performed in an argon or nitrogen atmosphere. Herein, the argon or nitrogen atmosphere means an atmosphere that contains 50% or more of argon or nitrogen gas. The mixed gas that contains 1 to 10% of hydrogen is more preferable. This is because oxidation of lithium-phosphorus-based composite oxide/carbon composite is prevented.

In the method for producing a lithium-phosphorus-based composite oxide/carbon composite, the baking can also be performed with the other lithium-containing compound(s) being combined. This lithium-containing compound includes composite oxide containing lithium and a transition metal element(s), and phosphate compounds containing lithium and a transition metal element(s). Among these lithium-containing compounds, a compound that contains one or more kinds of nickel, iron, manganese, and cobalt is preferable. They can be represented by chemical formulae of Li_{c}M1O₂ and Li_{d}M2PO₄, for example. In the formulae, M1 and M2 each represent one or more transition metal elements; and the vales of “c” and “d”, which show different values in accordance with the state of charging and discharging of the battery, are generally represented by 0.05≦c≦1.1, 0.05≦d≦1.1. Illustrative examples of the composite oxide containing lithium and a transition metal element(s) include lithium-cobalt composite oxide (Li_{c}CoO₂), lithium-nickel composite oxide (Li_{c}NiO₂); and illustrative examples of the phosphate compounds containing lithium and a transition metal element(s) include lithium-iron phosphate compounds (Li_{d}FePO₄) and lithium-iron-manganese phosphate compounds (Li_{d}Fe₁₋ₑMnₑPO₄ (0<e<1)). Because they can give higher battery capacity, together with excellent cycle properties.

In the above-described method for producing a lithium-phosphorus-based composite oxide/carbon composite, the lithium-phosphorus-based composite oxide-precursor and the lithium compound may be mixed and reacted by using a method other than the baking or by combining the baking and another method(s). For example, it is possible to perform hydrothermal processing, to increase the number of baking, to perform palletization prior to the baking, etc. in the reaction.

The method for producing a lithium-phosphorus-based composite oxide/carbon composite described above can surely produce a lithium-phosphorus-based composite oxide/carbon composite that has elutable fluoride ions, the elutable fluoride ions being eluted to an elute from the lithium-phosphorus-based composite oxide/carbon composite dispersed to ultrapure water, in the prescribed range of mass ratio described above in comparison with the lithium-phosphorus-based composite oxide/carbon composite.

The foregoing lithium-phosphorus-based composite oxide/carbon composite can be utilized as a positive electrode active material for various electrochemical devices (e.g., a battery, a sensor, an electrolytic bath). Herein, the “electrochemical device” is a wording that refers to devices containing electrode plate material to flow current, that is, the whole of devices capable of bringing electric energy, and a concept including an electrolytic bath, a primary battery, and a secondary battery. Furthermore, the “secondary battery” is a concept that includes so-called storage batteries such as a lithium ion secondary battery, a nickel-hydrogen battery, and a nickel-cadmium battery, as well as storage devices such as an electric double layer capacitor. The foregoing lithium composite oxide is particularly suitable as an electrode material of a lithium ion secondary battery and an electrolytic bath. The electrolytic bath may be in any shape as far as it has electrode plate material to flow current. The lithium ion secondary battery can be in any shapes of coin, button, sheet, cylinder, and square shape. The inventive lithium composite oxide can be applied to a lithium ion secondary battery for any use, which are not particularly limited, including electronic equipment such as a notebook computer, a laptop computer, a pocket-sized word processor, a cellular phone, a cordless phone, a portable CD player, and a radio, as well as consumer electronic equipment such as an automobile, an electric-powered vehicles, and a game player.

Hereinafter, each component of electrochemical devices and lithium ion secondary batteries in which the foregoing lithium composite oxide is applied.

### [Positive Electrode Active Material Layer]

The positive electrode active material layer can contain 50 to 100% by mass of the inventive lithium-phosphorus-based composite oxide/carbon composite. It may also contain any one kind or two or more kinds of positive electrode active material(s) that can occlude and release lithium ions, as well as other materials such as a binder, a conductive assistant, and dispersing agent in accordance with the design.

### [Positive Electrode]

The positive electrode has the positive electrode active material layer(s) at the both sides or one side of a current collector, for example. The current collector can be formed by conductive material such as aluminum.

### [Negative Electrode Active Material Layer]

The negative electrode active material is preferably any of silicon oxide shown by the general formula of SiOₓ (0.5≦x<1.6) or a mixture of two or more of these. The negative electrode active material layer contains the negative electrode active material, and may contain other materials such as a binder, a conductive assistant, and dispersing agent in accordance with the design.

### [Negative Electrode]

The negative electrode has the same structure as the positive electrode described above, and has the negative electrode active material layer(s) at the both sides or one side of a current collector, for example. This negative electrode preferably has a larger negative charge capacity compared to the electric capacity obtained from a lithium composite oxide active material (a charge capacity as a battery). Because this can suppress deposition of lithium metal on a negative electrode.

### [Binder]

As the binder, it is possible to use any one or more of polymer materials, synthetic rubbers, etc. Illustrative examples of the polymer materials include polyvinylidene fluoride, polyimide, polyamide imide, aramid, polyacrylic acid, lithium polyacrylate, and carboxymethyl cellulose. Illustrative examples of the synthetic rubbers include styrene-butadiene rubber, fluorine rubber, and ethylene-propylene diene rubber.

### [Conductive Assistant]

As a lithium composite oxide conductive assistant and a negative electrode conductive assistant, it is possible to use any one or more of carbon materials such as carbon black, acetylene black, graphite, ketjen black, carbon nanotube, carbon nanofiber.

### [Electrolytic Solution]

A separator or at least part of the active material layer is impregnated with liquid electrolyte (electrolytic solution). In this electrolytic solution, electrolyte salt is dissolved in solvent, and other materials such as additives may be contained. The solvent may be non-aqueous solvent. Illustrative examples of the non-aqueous solvent include ethylene carbonate, propylene carbonate, butylene carbonate, dimethyl carbonate, diethyl carbonate, ethyl methyl carbonate, methyl propyl carbonate, 1,2-dimethoxyethane, and tetrahydrofuran. Among them, it is preferable to use one or more of ethylene carbonate, propylene carbonate, dimethyl carbonate, diethyl carbonate, ethyl methyl carbonate, since better property can be obtained. In this case, more advantageous properties can be obtained by combining high-viscosity solvent such as ethylene carbonate and propylene carbonate, together with low-viscosity solvent such as dimethyl carbonate, ethyl methyl carbonate, and diethyl carbonate. Because this can improve the dissociative and ionic mobility of electrolyte salt.

It is particularly desirable that at least one kind of halogenated chain carbonate ester or halogenated cyclic carbonate ester is contained as the solvent. This makes it possible to form stable coat on the surface of the negative electrode active material during charge/discharge, especially during charge. The halogenated chain carbonate ester is chain carbonate ester having halogen as a constitutive element (at least one hydrogen is substituted with halogen). And the halogenated cyclic carbonate ester is cyclic carbonate ester having halogen as a constitutive element (at least one hydrogen is substituted with halogen).

Although the kind of halogen is not particularly limited, fluorine is more preferable, since it forms better coat compared to other halogens. As the number of halogen, the larger is better. Because this makes it possible to obtain more stable coat and to decrease decomposition reaction of the electrolytic solution. As the halogenated chain carbonate ester, fluoromethyl methyl carbonate, difluoromethyl methyl carbonate, etc. are illustrated. As the halogenated cyclic carbonate ester, 4-fluoro-1,3-dioxolane-2-one, 4,5-difluoro-1,3-dioxolane-2-one, etc. are illustrated.

It is preferable to contain cyclic carbonate ester having an unsaturated carbon bond as an additive to the solvent. Because this makes it possible to form stable coat on the surface of the negative electrode active material during charge/discharge to suppress decomposition reaction of the electrolytic solution. As the cyclic carbonate ester having an unsaturated carbon bond, vinylene carbonate, vinylethylene carbonate, etc. are illustrated. It is also preferable to contain sultone (cyclic sulfate ester) as an additive to the solvent, since chemical stability of a battery is improved. As the sultone, for example, propane sultone and propene sultone are illustrated.

Furthermore, the solvent preferably contains acid anhydride, since chemical stability of the electrolytic solution is improved. As the acid anhydride, for example, propane disulfonic anhydride is illustrated.

The electrolyte salt may contain any one or more of light metal salt such as lithium salt. As the lithium salt, for example, lithium hexafluorophosphate (LiPF₆), lithium tetrafluoroborate (LiBF₄) are illustrated. The content of the electrolyte salt is preferably 0.5 mol/kg or more and 2.5 mol/kg or less based on the solvent, since higher ion conductivity can be obtained.

### [Current Collector]

The current collector of the electrode is not particularly limited as far as it is an electronic conductive material that does not cause chemical change in the structured lithium ion secondary batteries and electrochemical devices. It is possible to use stainless steel, nickel, aluminum, titanium, baked carbon, and aluminum or stainless steel with the surface treated with carbon, nickel, copper, titanium, or silver, for example. Illustrative examples of the materials used for the negative electrode include stainless steel, nickel, copper, titanium, aluminum, and baked carbon; as well as copper or stainless steel with the surface treated with carbon, nickel, titanium, or silver; and Al—Cd alloy.

### [Separator]

The separator is a one which separates a positive electrode and a negative electrode, and allows lithium ions to pass with preventing current short due to a contact of both electrodes. This separator is formed of a porous film consists of synthetic resin or ceramic, for example, and may be contain a laminate structure in which two or more porous films are laminated. As the synthetic resin, polytetrafluoroethylene, polypropylene, polyethylene, etc. are illustrated, for example.

Subsequently, the inventive electrochemical device will be described.

The inventive electrochemical device is an electrochemical device, comprising:

a negative electrode composed of a negative electrode current collector and a negative electrode active material layer containing a particle of negative electrode active material that has charge/discharge efficiency of 80% or less when the particle of negative electrode active material is used as a negative electrode active material for the electrochemical device, and

a positive electrode composed of a positive electrode current collector and a positive electrode active material layer containing the lithium-phosphorus-based composite oxide/carbon composite described above. Further, the inventive electrochemical device may also be an electrochemical device, comprising:

a negative electrode composed of a negative electrode current collector and a negative electrode active material layer containing a particle of negative electrode active material that contains silicon oxide shown by the composition formula of SiOₓ (0.5≦x<1.6), and

a positive electrode composed of a positive electrode current collector and a positive electrode active material layer containing the lithium-phosphorus-based composite oxide/carbon composite described above. It is to be noted that the negative electrode and the positive electrode may be structured not to have a current collector.

Such an electrochemical device can have higher charge/discharge capacity.

It is to be noted that regenerated lithium-phosphorus-based composite oxide/carbon composites tend to increase the powder resistance. The increase of powder resistance cause lowering of the charge/discharge efficiency. Accordingly, it is preferable to use a particle of negative electrode active material that has charge/discharge efficiency of 80% or less since this brings good balance of charge/discharge efficiency between the positive electrode and the negative electrode to give stable charge/discharge current.

Subsequently, the inventive lithium ion secondary battery will be described.

The inventive lithium ion secondary battery is a lithium ion secondary battery, comprising:

a negative electrode composed of a negative electrode current collector and a negative electrode active material layer containing a particle of negative electrode active material that has charge/discharge efficiency of 80% or less when the particle of negative electrode active material is used as a negative electrode active material for the lithium ion secondary battery, and

a positive electrode composed of a positive electrode current collector and a positive electrode active material layer containing the lithium-phosphorus-based composite oxide/carbon composite described above. Further, the inventive lithium ion secondary battery may also be a lithium ion secondary battery, comprising:

a negative electrode composed of a negative electrode current collector and a negative electrode active material layer containing a particle of negative electrode active material that contains silicon oxide shown by the composition formula of SiOₓ (0.5≦x<1.6), and

a positive electrode composed of a positive electrode current collector and a positive electrode active material layer containing the lithium-phosphorus-based composite oxide/carbon composite described above. It is to be noted that the negative electrode and the positive electrode may be structured not to have a current collector.

Such a lithium ion secondary battery can have higher charge/discharge capacity.

### EXAMPLES

Hereinafter, the present invention will be more specifically described by showing Examples and Comparative Examples, but the present invention is not limited thereto.

### Examples 1 to 4

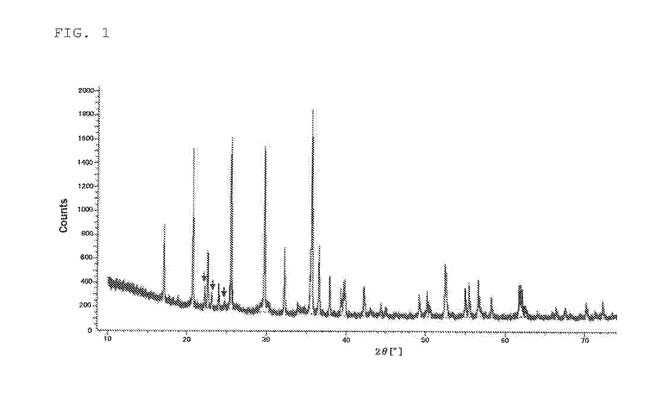

From LiFePO₄ (coated with carbon) pelletized, lithium was extracted to 50% at constant current to form Li_{0.5}FePO₄. This was dried, with the fluorine-containing electrolytic solution being contained, and was lightly ground into powder. To this powder, lithium hydroxide (LiOH.H₂O) was mixed so as to have an equivalent ratio of Li/Fe of 1.05/1.00. This mixture was baked in mixed gas of nitrogen-hydrogen (the hydrogen concentration: 3%), followed by cooling and pulverizing. Subsequently, this was classified with a sieve having an opening of 75 μm to produce a lithium-phosphorus-based composite oxide/carbon composite with a composition of LiFePO₄ having a peak corresponding to lithium phosphate, with the surface being coated with carbon. The baking conditions were set at 650° C. for 8 hours in Examples 1 and 2, at 650° C. for 10 hours in Example 3, and at 600° C. for 10 hours in Example 4. Regarding the powder obtained in Example 1, X-ray diffraction was measured. The obtained X-ray diffraction pattern is shown in FIG. 1. From FIG. 1, it was confirmed that the lithium-phosphorus-based composite oxide/carbon composite obtained in Example 1 showed a peak corresponding to lithium phosphate in a range of 20° or more and 25° or less in a 2θ value (the marked peaks in FIG. 1). In each of Examples 2 to 4, X-ray diffraction was measured in the same manner as in Example 1, and it was confirmed that a peak corresponding to lithium phosphate was observed.

### Examples 5 to 8

From LiFePO₄ pelletized, lithium was extracted to 50% at constant current to form Li_{0.5}FePO₄. This was washed with dimethyl carbonate (DMC), filtered, dried, and lightly ground into powder. To this powder, lithium hydroxide (LiOH.H₂O) and lithium hexafluoro (LiPF₆, 5% of the total amount of added lithium) were mixed so as to have an equivalent ratio of Li/Fe of 1.05/1.00, and then, sucrose (cane sugar: C₁₂H₂₂O₁₁) was mixed. This mixture was baked in nitrogen gas, followed by cooling and pulverizing. Subsequently, this was classified with a sieve having an opening of 75 μm to produce a lithium-phosphorus-based composite oxide/carbon composite with a composition of LiFePO₄ having a peak corresponding to lithium phosphate, with the surface being coated with carbon. The baking conditions were set at 700° C. for 3 hours in Example 5, at 580° C. for 4 hours in Example 6, at 750° C. for 4 hours in Example 7, and at 550° C. for 5 hours in Example 8. In each of Examples 5 to 8, X-ray diffraction was also measured in the same manner as in Example 1, and it was confirmed that a peak corresponding to lithium phosphate was observed.

### Examples 9 to 11

From LiFePO₄ pelletized, lithium was extracted to 50% at constant current to form Li_{0.5}FePO₄. This was dried, with the fluorine-containing electrolytic solution being contained, and was lightly ground into powder. To this powder, lithium hydroxide (LiOH.H₂O) and lithium tetrafluoroborate (LiBF₄, 5% of the total amount of added lithium) were mixed so as to have an equivalent ratio of Li/Fe of 1.05/1.00, and then, sucrose (cane sugar: C₁₂H₂₂O₁₁) was mixed. This mixture was baked in argon gas, followed by cooling and pulverizing. Subsequently, this was classified with a sieve having an opening of 75 μm to produce a lithium-phosphorus-based composite oxide/carbon composite with a composition of LiFePO₄ having a peak corresponding to lithium phosphate, with the surface being coated with carbon. The baking conditions were set at 780° C. for 4 hours in Example 9, at 650° C. for 4 hours in Example 10, and at 650° C. for 4 hours in Example 11. In each of Examples 9 to 11, X-ray diffraction was also measured in the same manner as in Example 1, and it was confirmed that a peak corresponding to lithium phosphate was observed.

### Comparative Examples 1 to 5

From LiFePO₄ pelletized, lithium was extracted to 50% at constant current to form Li_{0.5}FePO₄. This was dried, with the fluorine-containing electrolytic solution being contained, and was lightly ground into powder. To this powder, lithium hydroxide (LiOH.H₂O) was mixed so as to have an equivalent ratio of Li/Fe of 1.05/1.00. This mixture was baked in argon gas, followed by cooling and pulverizing. Subsequently, this was classified with a sieve having an opening of 75 μm to produce a lithium-phosphorus-based composite oxide/carbon composite with a composition of LiFePO₄ having a peak corresponding to lithium phosphate. The baking conditions were set at 500° C. for 10 hours in Comparative Example 1, at 900° C. for 10 hours in Comparative Example 2, and at 650° C. for 5 hours in Comparative Examples 3 to 5. In each of Comparative Examples 1 to 5, X-ray diffraction was also measured in the same manner as in Example 1, but a peak corresponding to lithium phosphate was not observed.

### (Measurement of Average Particle Size (Median Diameter))

The particle size distribution was measured on each lithium-phosphorus-based composite oxide/carbon composite of Examples 1 to 11 and Comparative Examples 1 to 5 by using Microtrac MK-II (SRA) (LEED & NORTHRUP, laser scattering light detector type) and by using ion-exchange water as dispersion medium.

The following are dispersant, reflux volume, and ultrasonic output in the measurements of particle size distribution:

dispersant: 10% aqueous sodium hexametaphosphate 2 ml
reflux volume: 40 ml/sec
ultrasonic output: 40 W for 60 seconds

The measured results of average particle sizes are shown in Table 1.

### (Measurement of BET Specific Surface Area)

The BET specific surface area of each lithium-phosphorus-based composite oxide/carbon composite of Examples 1 to 11 and Comparative Examples 1 to 5 was measured by using FlowSorb 2300 (manufactured by Shimadzu Corporation).

The measured results of BET specific surface areas are shown in Table 1.

### (Measurement of Mass of Eluted Fluoride Ions)

The mass of elutable fluoride ions, which was eluted to an elute from each lithium-phosphorus-based composite oxide/carbon composite of Examples 1 to 11 and Comparative Examples 1 to 5 dispersed to ultrapure water, was measured by high frequency inductively-coupled plasma (ICP) method. Each mass ratio in comparison with the lithium-phosphorus-based composite oxide/carbon composite was calculated. The obtained mass ratios are shown in Table 1.

### (Measurement of Mass of Eluted Lithium Ions)

The mass of elutable lithium ions, which was eluted to an elute from each lithium-phosphorus-based composite oxide/carbon composite of Examples 1 to 11 and Comparative Examples 1 to 5 dispersed to ultrapure water, was measured, and each mass ratio in comparison with the lithium-phosphorus-based composite oxide/carbon composite was calculated by means of high frequency inductively-coupled plasma (ICP) method. The obtained mass ratios are shown in Table 1. Each mass ratio of the eluted fluoride ions and the eluted lithium ions (the mass of the fluoride ions/the mass of the lithium ions) is also shown in Table 1.

### (Measurement of Carbon Content)

Regarding the lithium-phosphorus-based composite oxide/carbon composites of Examples 1 to 11 and Comparative Examples 1 to 5, carbon contents were measured by using a carbon analyzer (HORIBA EMIA-110).

The measured results are shown in Table 1.

### <Performance Tests of Batteries>

### (Preparation of Positive Electrode)

Positive electrodes were prepared by using the lithium-phosphorus-based composite oxide/carbon composites of Examples 1 to 11 and Comparative Examples 1 to 5 produced as described above. By mixing 88% by mass of the produced lithium-phosphorus-based composite oxide/carbon composite, 4.0% by mass of graphite powder, and 8.0% by mass of polyvinylidene fluoride, a positive electrode material was prepared. This was dispersed into N-methyl-2-pyrrolidinone (hereinafter, referred to as NMP) to prepare a mixed paste. The mixed paste was applied onto an aluminum foil (current collector) and dried. This was pressed, whereby a disc with a diameter of 15 mm was punched out to give a positive electrode plate.

### (Preparation of Negative Electrode)

Then, an SiO negative electrode was prepared. As the SiO negative electrode, a mixed raw material of metal silicon and silicon dioxide were introduced into a reaction furnace and deposited in an atmosphere of a vacuum of 10 Pa. After this was sufficiently cooled, the deposit was taken out and ground by a ball mill. The particle size was adjusted, and then covered with a carbon layer by thermal decomposition CVD according to a necessity. The prepared powder was subjected to inner-bulk reforming in a 1:1 mixed solvent of propylene carbonate and ethylene carbonate (electrolyte salt: 1.3 mol/Kg) with using an electrochemical method. The obtained material was subjected to drying treatment under a carbonic acid atmosphere according to a necessity. Subsequently, the particle of negative electrode active material and a precursor of a negative electrode binder, a conductive assistant 1 (ketjen black), and a conductive assistant 2 (acetylene black) were mixed in a dried-weight ratio of 80:8:10:2 to form a negative electrode material, and then diluted by NMP to form paste-state negative electrode material slurry. In this case, NMP was used as a solvent of polyamic acid. Then the negative electrode material slurry was applied to a negative electrode current collector with a coating apparatus, followed by drying. As this negative electrode current collector, electrolytic copper foil (thickness=15 μm) was used. Lastly, it was baked at 400° C. for 1 hour in a vacuum atmosphere. By this baking step, negative electrode binder (polyimide) was formed. This was pressed, whereby a disc with a diameter of 16 mm was punched out to give a negative electrode plate.

### (Preparation of Coin-Shaped Non-Aqueous Electrolyte Secondary Battery)

A coin-shaped non-aqueous electrolyte secondary battery was prepared by using the prepared positive electrode plate and negative electrode plate, as well as each parts such as a separator, metal attachment, outside terminals, and electrolytic solution. The electrolytic solution was prepared by dissolving 1 mole of LiPF₆ in 1 L of 2:7:1 mixed solvent of ethylene carbonate, didiethyl carbonate, and fluoroethylene carbonate.

### (Measurement of Discharge Capacity of Positive Electrode)

The coin-shaped lithium ion secondary battery prepared as described above was subjected to a charge/discharge test of charging to 4.00 V at a constant voltage and a constant current with using a current corresponding to 0.5 C for 5 hours and subsequent discharging to 2.5 V with using current corresponding to 0.1 C, whereby the initial discharge capacity (mAh/g) of the positive electrode was measured. The measured results are shown in Table 1.

TABLE 1

| | | BET | | | | | | | | | |
|---|---|---|---|---|---|---|---|---|---|---|---|
| | Average | specific | | | | | | | | | |
| | particle | surface | Discharge | Baking | Baking | | | Eluted | | Carbon | Peak |
| | size | area | capacity | temp. | time | Baking | Eluted F | Li | | content | of Li |
| | (μm) | (m²/g) | (mAh/g) | (° C.) | (h) | atmosphere | (ppm) | (ppm) | F/Li | (mass %) | phosphate |
| Example 1 | 10.2 | 26.20 | 162 | 650 | 8 | N₂ + H₂ (3%) | 5350 | 1500 | 3.57 | 6.00 | Exist |
| Example 2 | 15.2 | 24.50 | 161 | 650 | 8 | N₂ + H₂ (3%) | 6200 | 1800 | 3.44 | 5.40 | Exist |
| Example 3 | 13.8 | 31.00 | 155 | 650 | 10 | N₂ + H₂ (3%) | 2700 | 620 | 4.35 | 3.20 | Exist |
| Example 4 | 12.1 | 21.00 | 158 | 600 | 10 | N₂ + H₂ (3%) | 5800 | 1270 | 3.75 | 9.10 | Exist |
| Example 5 | 10.4 | 15.10 | 154 | 700 | 3 | N₂ | 12580 | 4500 | 2.80 | 2.00 | Exist |
| Example 6 | 14.6 | 12.80 | 157 | 580 | 4 | N₂ | 3250 | 3000 | 1.08 | 2.10 | Exist |
| Example 7 | 12.1 | 7.20 | 155 | 750 | 4 | N₂ | 1450 | 3540 | 0.41 | 2.5 | Exist |
| Example 8 | 0.6 | 48.20 | 144 | 550 | 5 | N₂ | 14500 | 2010 | 7.21 | 15.7 | Exist |
| Example 9 | 29.5 | 8.35 | 138 | 780 | 4 | Ar | 510 | 4800 | 0.11 | 1.10 | Exist |
| Example 10 | 13.8 | 18.00 | 142 | 650 | 4 | Ar | 8900 | 920 | 9.67 | 2.10 | Exist |
| Example 11 | 16.8 | 20.50 | 144 | 650 | 4 | Ar | 9500 | 2000 | 4.75 | 2.20 | Exist |
| Comparative | 0.4 | 50.50 | 121 | 500 | 10 | Ar | 16700 | 1650 | 10.12 | 21.00 | None |
| Example 1 | | | | | | | | | | | |
| Comparative | 31.5 | 4.20 | 125 | 900 | 10 | Ar | 350 | 5200 | 0.07 | 1.00 | None |
| Example 2 | | | | | | | | | | | |
| Comparative | 16.1 | 20.20 | 123 | 650 | 5 | Ar | 120 | 8500 | 0.01 | 3.10 | None |
| Example 3 | | | | | | | | | | | |
| Comparative | 12.8 | 23.50 | 125 | 650 | 5 | Ar | 480 | 400 | 1.20 | 1.80 | None |
| Example 4 | | | | | | | | | | | |
| Comparative | 15.2 | 27.60 | 121 | 650 | 5 | Ar | 15500 | 2800 | 5.54 | 2.00 | None |
| Example 5 | | | | | | | | | | | |

As can be seen from Table 1, higher discharge capacity was obtained in the coin-shaped non-aqueous electrolyte secondary battery prepared by using each lithium-phosphorus-based composite oxide/carbon composite of Examples 1 to 11, in which fluoride ions were eluted to an elute from the composite dispersed to ultrapure water, in the mass ratio of 500 ppm or more and 15000 ppm or less in comparison with the lithium-phosphorus-based composite oxide/carbon composite, compared to the coin-shaped non-aqueous electrolyte secondary battery prepared by using each lithium-phosphorus-based composite oxide/carbon composite of Comparative Examples 1 to 5, in which fluoride ions were eluted to an elute from the composite dispersed to ultrapure water in the mass ratio of less than 500 ppm or more than 15000 ppm in comparison with the lithium-phosphorus-based composite oxide/carbon composite.

It is to be noted that the present invention is not limited to the foregoing embodiment. The embodiment is just an exemplification, and any examples that have substantially the same feature and demonstrate the same functions and effects as those in the technical concept described in claims of the present invention are included in the technical scope of the present invention.

1-18. (canceled)

19. A lithium-phosphorus-based composite oxide/carbon composite used for a positive electrode active material of an electrochemical device, comprising lithium-phosphorus-based composite oxide with the surface being coated with carbon,
wherein the lithium-phosphorus-based composite oxide/carbon composite has elutable fluoride ions, the elutable fluoride ions being eluted to an elute from the lithium-phosphorus-based composite oxide/carbon composite when the lithium-phosphorus-based composite oxide/carbon composite is dispersed to ultrapure water, in a mass ratio of 500 ppm or more and 15000 ppm or less in comparison with the lithium-phosphorus-based composite oxide/carbon composite, and
the lithium-phosphorus-based composite oxide has a composition of the following general formula (1):
Li₁₋ₓFe_{1-z}M_{z}PO₄₋ₐFₐ(−0.1≦x<1,0≦z≦1,0≦a≦4) (1)
(wherein, M represents one or more kinds of metal element selected from the group of Mn, Ni, Co, V, Cr, Al, Nb, Ti, Cu, and Zn).

20. The lithium-phosphorus-based composite oxide/carbon composite according to claim 19, wherein the lithium-phosphorus-based composite oxide/carbon composite has elutable lithium ions, the elutable lithium ions being eluted to an elute from the lithium-phosphorus-based composite oxide/carbon composite when the lithium-phosphorus-based composite oxide/carbon composite is dispersed to ultrapure water, in a mass ratio of 500 ppm or more and 5000 ppm or less in comparison with the lithium-phosphorus-based composite oxide/carbon composite.

21. The lithium-phosphorus-based composite oxide/carbon composite according to claim 19, wherein the lithium-phosphorus-based composite oxide/carbon composite has elutable lithium ions and the elutable fluoride ions, the elutable lithium ions and the elutable fluoride ions being eluted to an elute from the lithium-phosphorus-based composite oxide/carbon composite dispersed to ultrapure water, in a mass ratio (the mass of the fluoride ions/the mass of the lithium ions) of 0.1 or more and 10 or less.

22. The lithium-phosphorus-based composite oxide/carbon composite according to claim 20, wherein the lithium-phosphorus-based composite oxide/carbon composite has elutable lithium ions and the elutable fluoride ions, the elutable lithium ions and the elutable fluoride ions being eluted to an elute from the lithium-phosphorus-based composite oxide/carbon composite dispersed to ultrapure water, in a mass ratio (the mass of the fluoride ions/the mass of the lithium ions) of 0.1 or more and 10 or less.

23. The lithium-phosphorus-based composite oxide/carbon composite according to claim 19, wherein the lithium-phosphorus-based composite oxide/carbon composite has a peak corresponding to lithium phosphate in a range of 20° or more and 25° or less in a 2θ value of X-ray diffraction measurement.

24. The lithium-phosphorus-based composite oxide/carbon composite according to claim 20, wherein the lithium-phosphorus-based composite oxide/carbon composite has a peak corresponding to lithium phosphate in a range of 20° or more and 25° or less in a 2θ value of X-ray diffraction measurement.

25. The lithium-phosphorus-based composite oxide/carbon composite according to claim 19, wherein the lithium-phosphorus-based composite oxide/carbon composite has an average particle size of 0.5 μm or more and 30.0 μm or less.

26. The lithium-phosphorus-based composite oxide/carbon composite according to claim 19, wherein the lithium-phosphorus-based composite oxide/carbon composite has a BET specific surface area of 5.0 m²/g or more and 50.0 m²/g or less.

27. A method for producing a lithium-phosphorus-based composite oxide/carbon composite containing lithium-phosphorus-based composite oxide having a composition of the following general formula (1) with the surface being coated with carbon:
Li₁₋ₓFe_{1-z}M_{z}PO₄₋ₐFₐ(−0.1≦x<1,0≦z≦1,0≦a≦4) (1)
(wherein, M represents one or more kinds of metal element selected from the group of Mn, Ni, Co, V, Cr, Al, Nb, Ti, Cu, and Zn), comprising the steps of:
mixing and then reacting a lithium compound and a lithium-phosphorus-based composite oxide-precursor having a composition of the following general formula (2) with the lithium being extracted:
Li_{1-y}Fe_{1-z}M_{z}PO_{4-b}F_{b}(x<y<1,0≦z≦1,0≦b≦4) (2)
(wherein, M represents one or more kinds of metal element selected from the group of Mn, Ni, Co, V, Cr, Al, Nb, Ti, Cu, and Zn),
using a carbon coated lithium-phosphorus-based composite oxide-precursor as the lithium-phosphorus-based composite oxide-precursor, or coating the lithium-phosphorus-based composite oxide-precursor or the lithium-phosphorus-based composite oxide with carbon,
wherein, by using as the lithium-phosphorus-based composite oxide-precursor or the lithium compound the precursor or the compound containing fluorine, the produced lithium-phosphorus-based composite oxide/carbon composite has elutable fluoride ions, the elutable fluoride ions being eluted to an elute when the lithium-phosphorus-based composite oxide/carbon composite is dispersed to ultrapure water, in a mass ratio of 500 ppm or more and 15000 ppm or less in comparison with the lithium-phosphorus-based composite oxide/carbon composite.

28. The method for producing a lithium-phosphorus-based composite oxide/carbon composite according to claim 27, wherein the lithium-phosphorus-based composite oxide-precursor is a lithium-phosphorus-based composite oxide-precursor with the lithium being extracted electrochemically.

29. The method for producing a lithium-phosphorus-based composite oxide/carbon composite according to claim 27, wherein the lithium-phosphorus-based composite oxide-precursor is a lithium-phosphorus-based composite oxide-precursor with the lithium being extracted electrochemically after molding the lithium-phosphorus-based composite oxide-precursor so as to have a thickness of 1.0 mm or more.

30. The method for producing a lithium-phosphorus-based composite oxide/carbon composite according to claim 27, wherein the lithium compound contains lithium hexafluorophosphate (LiPF₆).

31. The method for producing a lithium-phosphorus-based composite oxide/carbon composite according to claim 27, wherein the lithium compound contains lithium tetrafluoroborate (LiBF₄).

32. The method for producing a lithium-phosphorus-based composite oxide/carbon composite according to claim 27, wherein the reacting step includes a baking stage, and
in the baking stage, the baking temperature is 500° C. or more and 1000° C. or less.

33. The method for producing a lithium-phosphorus-based composite oxide/carbon composite according to claim 27, wherein the reacting step includes a baking stage, and
the baking stage is performed in a nitrogen atmosphere.

34. The method for producing a lithium-phosphorus-based composite oxide/carbon composite according to claim 27, wherein the reacting step includes a baking stage, and
the baking stage is performed in an argon atmosphere.

35. An electrochemical device, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the electrochemical device; and
a positive electrode composed of a positive electrode current collector and a positive electrode active material layer containing the lithium-phosphorus-based composite oxide/carbon composite according to claim 19.

36. An electrochemical device, comprising:
a negative electrode composed of a negative electrode current collector and a negative electrode active material layer containing a particle of negative electrode active material that contains silicon oxide shown by the composition formula of SiOₓ (0.5≦x<1.6); and
a positive electrode composed of a positive electrode current collector and a positive electrode active material layer containing the lithium-phosphorus-based composite oxide/carbon composite according to claim 19.

37. A lithium ion secondary battery, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the lithium ion secondary battery; and
a positive electrode composed of a positive electrode current collector and a positive electrode active material layer containing the lithium-phosphorus-based composite oxide/carbon composite according to claim 19.

38. A lithium ion secondary battery, comprising:
a negative electrode composed of a negative electrode current collector and a negative electrode active material layer containing a particle of negative electrode active material that contains silicon oxide shown by the composition formula of SiOₓ (0.5≦x<1.6); and
a positive electrode composed of a positive electrode current collector and a positive electrode active material layer containing the lithium-phosphorus-based composite oxide/carbon composite according to claim 19.
